(19) United States
(12) Patent Application Publication
(10) Pub. No.: US 2014/0141708 A1
(43) Pub. Date: May 22, 2014

(54) Ventilation Systems and Related Methods

(71) Applicant: DNKB, INC., Phoenix, AZ (US)

(72) Inventor: Dwayne Anthony Baker, Phoenix, AZ (US)

(73) Assignee: DNKB, INC., Phoenix, AZ (US)

(21) Appl. No.: 14/086,432

(22) Filed: Nov. 21, 2013

Related U.S. Application Data
(60) Provisional application No. 61/728,991, filed on Nov. 21, 2012.
(60) Provisional application No. 61/789,531, filed on Mar. 15, 2013.

(51) Int. Cl. F24F 7/08; F04D 29/60; A01K 1/01; F24F 13/28

(52) U.S. Cl. CPC F24F 7/08; F24F 13/28; F04D 29/60; A01K 1/0107
USPC 454/249; 417/423.9; 417/423.15

(57) ABSTRACT

A ventilation system includes a housing having an inlet and an outlet to facilitate air flow, a fan coupled within the housing, a filter removably coupled within the housing and a litter box coupled to the housing. In implementations the ventilation system defines a flow direction for air exiting the litter box and the fan is positioned prior to the filter in the flow direction. In implementations an adhesive element having an opening is coupled to the bottom of the housing and the opening is aligned with the inlet, and a transparent coupler is coupled to the adhesive element, the transparent coupler blocking at least one vent of the litter box and the transparent coupler having an opening aligned with the inlet. In implementations the ventilation system defines substantially only a single flow direction for the air flow, the flow direction being in an upwards direction from the litter box.

### CROSS REFERENCE TO RELATED APPLICATIONS

This document claims the benefit of the filing date of U.S. Provisional Patent Application Ser. No. 61/728,991, entitled “Ventilation System and Related Methods,” naming as first inventor Dwayne Anthony Baker, which was filed on Nov. 21, 2012, and U.S. Provisional Patent Application Ser. No. 61/789,531, entitled “Ventilation System and Associated Methods,” naming as first inventor Dwayne Anthony Baker, which was filed on Mar. 15, 2013, the disclosures of which are hereby incorporated entirely herein by reference.

### BACKGROUND

1. Technical Field

Aspects of this document relate generally to ventilation systems. Specific implementations relate to ventilation systems for pet litter boxes.

2. Background Art

Ventilation systems generally are used to ventilate air and/or to deodorize air. Some ventilation systems and/or deodorizing systems are used to reduce or remove unpleasant odors from a pet container or a pet litter box.

### SUMMARY

Implementations of ventilation systems may include: a housing including an inlet section having an inlet configured for air to pass through and an outlet section removably coupled to the inlet section, the outlet section having an outlet configured for air to pass through; a fan coupled entirely within the housing; and a filter removably coupled entirely within the housing; wherein the housing is configured to be coupled to a litter box, wherein the ventilation system defines a flow direction for air exiting the litter box, and wherein the fan is positioned prior to the filter in the flow direction.

Implementations of ventilation systems may include one, all, or any of the following:

A litter box may be coupled to the housing.

The inlet section may have a shape of a hollow cuboid with one face removed.

The outlet section may be a flat lid.

A coupler may be coupled to the litter box and may be blocking at least one vent of the litter box. The coupler may have an opening aligned with the inlet.

An adhesive element may be coupled to the inlet section and may have an opening substantially aligned with the inlet. The adhesive element may be coupled to one of the litter box and a coupler coupled to the litter box.

The inlet may include a circular vent and the outlet may include a circular vent.

The housing may be coupled to the litter box only at a top of the litter box.

The filter may be the topmost item within the housing below the outlet section.

Implementations of ventilation systems may include: a housing including an inlet section having an inlet configured for air to pass through and an outlet section removably coupled to the inlet section, the outlet section having an outlet configured for air to pass through; a fan coupled entirely within the housing; a filter removably coupled entirely within the housing; an adhesive element coupled to a bottom of the housing and having an opening aligned with the inlet; a transparent coupler coupled to the adhesive element; and a litter box coupled to the transparent coupler; wherein the transparent coupler blocks at least one vent of the litter box and wherein the transparent coupler has an opening aligned with the inlet.

Implementations of ventilation systems may include one, all, or any of the following:

The inlet section may have a shape of a hollow cuboid with one face removed.

The outlet section may be a flat lid.

The filter may be the topmost item within the housing below the outlet section.

The ventilation system may be configured to allow the filter to be removed and replaced while the inlet section is coupled to the litter box.

Implementations of ventilation systems may include: a housing including an inlet section having an inlet configured for air to pass through and an outlet section removably coupled to the inlet section, the outlet section having an outlet configured for air to pass through; a fan coupled entirely within the housing; a filter removably coupled entirely within the housing; and a litter box coupled to the housing; wherein the ventilation system defines substantially only a single flow direction for air exiting the litter box, the flow direction being vertically upwards from the litter box.

Implementations of ventilation systems may include one, all, or any of the following:

The ventilation system may define only a single, vertical, cylindrical column within which the air exiting the litter box flows.

The inlet may include a circular vent and the outlet may include a circular vent coaxial with the circular vent of the inlet.

The inlet section may have a shape of a hollow cuboid with one face removed.

The outlet section may be a flat lid.

The filter may be the topmost item within the housing below the outlet section.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

Implementations will hereinafter be described in conjunction with the appended drawings, where like designations denote like elements, and:

FIG. 1 is an exploded view of an implementation of a ventilation system;

FIG. 2 is a front cross-sectional view of an implementation of a filter housing, filter and guard of the ventilation system of FIG. 1 taken along line 2-2;

FIG. 3 is a top perspective view of an implementation of an inlet section and an adhesive element of a ventilation system;

FIG. 4 is a bottom view of an implementation of an inlet section of a ventilation system;

FIG. 5 is a top perspective view of an implementation of a coupler of a ventilation system;

FIG. 6 is a bottom perspective view of an implementation of an inlet section and a top perspective view of a coupler of a ventilation system;

FIG. 7 is a top perspective view of a ventilation system coupled to a litter box;

FIG. 8 is a bottom perspective partial-cutaway view of a coupler coupled to a litter box; and

FIG. 9 is an exploded view of an implementation of a ventilation system.

### DESCRIPTION

This disclosure, its aspects and implementations, are not limited to the specific components, assembly procedures or method elements disclosed herein. Many additional components, assembly procedures and/or method elements known in the art consistent with the intended ventilation systems and related methods will become apparent for use with particular implementations from this disclosure. Accordingly, for example, although particular implementations are disclosed, such implementations and implementing components may comprise any shape, size, style, type, model, version, measurement, concentration, material, quantity, method element, step, and/or the like as is known in the art for such ventilation systems and related methods, and implementing components and methods, consistent with the intended operation and methods.

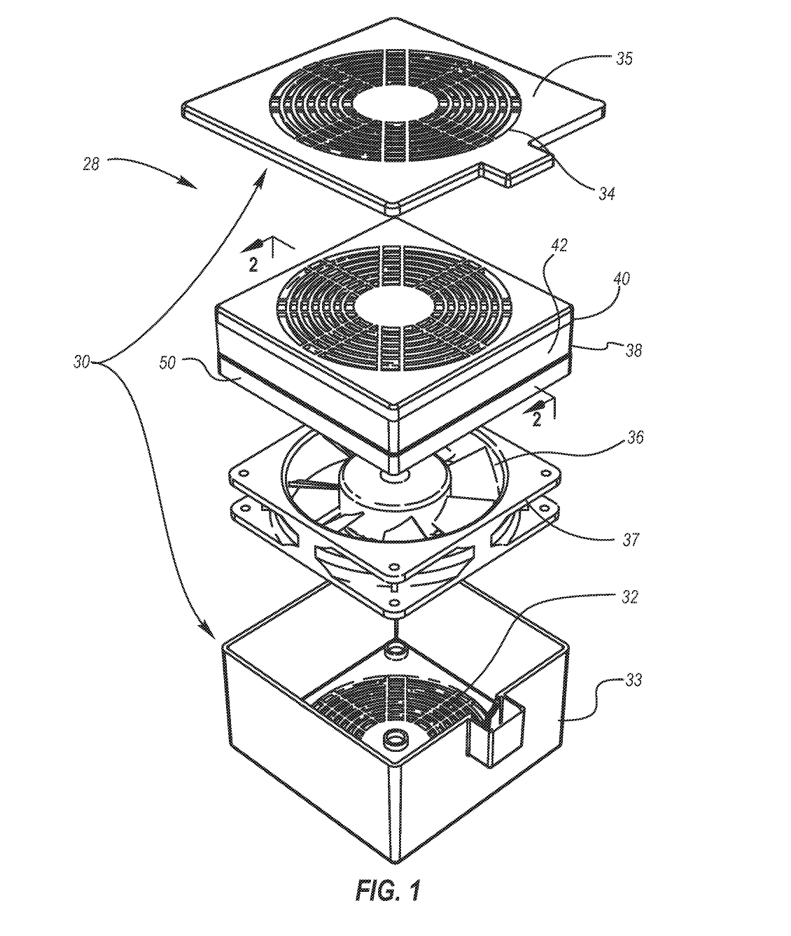

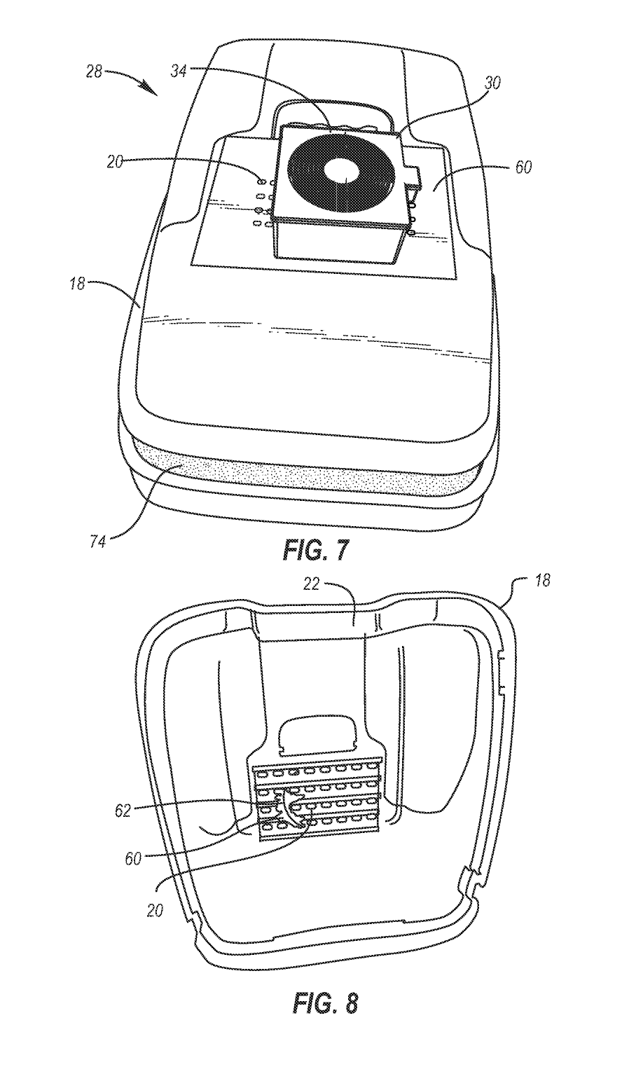

Referring to FIGS. 1-9, in implementations a ventilation system 28 includes a housing 30, a fan 36 coupled to the housing 30, a filter 70 coupled to the housing 30 and configured to reside in the pathway of air being drawn through the ventilation system 28 by the fan 36, an adhesive element 66 configured to couple the housing 30 to a container 18 and/or to a coupler 60, and a coupler 60 configured to couple to the container 18 and to cover, or partially cover, one or more vents 20 of the container 18. In implementations the housing 30 may be directly attached to a container 18 using the adhesive element 66, without the use of the coupler 60. The container 18 is an item to be ventilated. In implementations the container 18 may be, by non-limiting example: a pet container; an animal container; a litter box; a cat box; a sandbox; a litter tray; a litter pan; and any other container configured to house an animal and/or to contain feces and/or urine of an animal such as a cat, a dog, a rabbit, a ferret, and any other animal. For instance, referring to FIG. 7, in implementations the container 18 could be a litter box having a litter material 74 into which the animal or pet defecates or urinates. In implementations the container 18 may be, by non-limiting example, something other than a pet container or litter box, such as a trash can or other item.

In implementations the housing 30 is coupled to the fan 36, the filter 70 and the adhesive element 66. In implementations the fan 36 and the fan housing 37 reside within the housing 30, though in implementations the fan 36 and fan housing 37 could be coupled to an outside of the housing 30. In implementations the fan 36 resides within the housing 30 between the inlet 32 and the outlet 34, but in other implementations the fan 36 could be located in front of the inlet 32 or aft of the outlet 34. In any case the inlet 32, outlet 34, fan 36 and filter 70 are organized such that air exiting the container 18, due to the fan 36, passes through the inlet 32, the outlet 34 and the filter 70 in any order. For example, in implementations air exiting the container 18 by the fan 36 would enter the housing 30 through the inlet 32, would pass through the filter 70, would pass by the fan 36, and then would exit the housing 30 through the outlet 34. In other implementations the air could pass through the aforementioned items in any order (for example the inlet 32, outlet 34, filter 70 and fan 36 may be organized in any order so long as some of the air exiting the container 18 is forced to pass through the filter 70). In implementations the ventilation system 28 could be configured to operate in reverse such as to pump air into the container 18.

The housing 30 in implementations has roughly the shape of a cuboid but in other implementations the housing 30 could be roughly the shape of a cylinder, or roughly the shape of a semi-sphere, or roughly any other regular or irregular shape. The housing 30 in implementations has an at least partially hollow interior to accommodate one or more items such as a fan housing 37 having a fan 36 and a filter housing 38 having a filter 70. In implementations the housing 30 is made of a polymeric material, such as a plastic, though in other implementations it could be made of any other material such as a metal, a composite, and so forth.

In implementations the housing 30 includes an inlet 32. The inlet 32 allows air to pass into (and, if the ventilation system 28 operates in reverse, out of) the housing 30. The inlet 32 in implementations may include slits, holes, or any other regular or irregularly sized or shaped openings in the housing 30, in any number and in any configuration.

In implementations the housing 30 includes an outlet 34. The outlet 34 allows air to pass out of (and, if the ventilation system 28 operates in reverse, into) the housing 30. The outlet 34 in implementations includes slits, though in other implementations the outlet 34 may include holes or any other regular or irregularly sized or shaped openings in the housing 30, in any number and in any configuration.

In implementations the housing 30 couples to a filter housing 38. The filter housing 38 in implementations is configured to receive a filter 70. The filter housing 38 in implementations includes structural elements which are configured to seat the filter 70 such that it is in a position between the outlet 34 and the fan 36. In other implementations the filter housing 38 could be integral to or coupled to the housing 30 and/or could couple the filter 70 to an outside of the housing 30, such as by screws, tabs, or any other coupling element, and/or could couple the filter 70 in front of the inlet 32 or aft of the outlet 34, for example. In implementations the filter housing 38 is configured to releasably receive the filter 70 so that one filter 70 may be changed out and replaced with another filter 70.

The ventilation system 28 in implementations includes a fan 36 coupled to the housing 30. The fan 36 may be coupled within the housing 30 or may be coupled to the outside of the housing 30, such as coupled before (or in front of) the inlet 32, or aft of the outlet 34, and so forth. The fan 36 is coupled to a motor that may be powered in any manner. In implementations the motor may be powered by batteries, such as rechargeable or non-rechargeable batteries, while in other implementations the motor may be powered through a standard power cord plugged into a standard electrical outlet. The motor in implementations could be powered by a photovoltaic energy conversion device such as solar panels. The fan 36 may be made of any material and may have any number of blades having any angle and/or pitch and may be configured to operate at any speed and/or at varying speeds. In implementations the fan 36 may have multiple speed settings. In implementations the fan 36 may have a shutoff or a timer setting whereby the fan 36 may be configured to run for a preset amount of time and then automatically stop, or run automatically at certain times or intervals, and so forth. The fan 36 may, by non-limiting example, be made of a plastic or polymeric material or a metal or composite material.

In implementations the ventilation system 28 includes a filter 70 or 72 coupled to the housing 30, the filter 70/72 including a filter material. The filter 70/72 in implementations may be configured to filter particulates, contaminants, odorous elements, odors, and the like from the air prior to the air exiting the ventilation system 28 to the ambient air outside of the container 18. By non-limiting example, in implementations the filter material of the filter 70/72 may include one, more, or all of the following: fibrous materials configured to remove solid particulates such as dust, pollen, mold, and bacteria; an absorbent; a chemical component for removal of airborne molecular contaminants; charcoal; and activated carbon. In implementations the filter material of the filter 70/72 may include activated carbon to remove contaminants and impurities such as, by non-limiting example, through chemical adsorption. In implementations activated carbon of the filter 70/72 may be used to reduce or remove odors exiting the container 18. The filter 70/72 in implementations may include the filter material within a filter container such as a bag, a mesh material, a plastic structure with openings, or some other breathable container containing activated carbon within the filter container. The filter container may have any shape such as, by non-limiting example, a shape matching the filter housing 38 or the housing 30, or any component of either, so as to be easily introduced into and removed from the same. In implementations the filter container may have roughly the shape of a cuboid, roughly the shape of a cylinder, roughly the shape of a pillow, and so forth. In implementations the filter 70/72 may be exchanged for a different filter 70/72 as desired by the user. In implementations the filter 70/72 includes a polyester media that is impregnated with activated carbon to remove or reduce pet odors, ammonia, bacteria-filled dust, and the like. In implementations the filter 70/72 includes an outer layer that includes a polyester media impregnated with activated carbon and a virgin coconut shell activated carbon inner layer that includes zeolite coated carbon.

The ventilation system 28 in implementations includes an adhesive element 66 configured to couple the housing 30 to the container 18 or to the coupler 60. In implementations the coupler 60 may be configured to close one or more vents 20 of the container 18 (such as may be seen in FIGS. 7-8). For example, the coupler 60 could be configured to cover all of the vents 20 and/or other openings of the container 18, apart from the door 22, except for those vents 20 which are in air communication with the ventilation system 28 so that substantially all of the air exiting the container 18 during operation of the ventilation system 28 exits through the ventilation system 28 and is thus forced to pass through the filter 70/72. In such a scenario substantially all of the air entering the container 18 may enter through the door 22. In other implementations the coupler 60 may be configured to cover some, but not all, of the vents 20 of the container 18. In implementations the coupler 60 may be configurable to different sizes and/or shapes by a user after purchase.

For example, in implementations the coupler 60 may include a relatively thin adhesive material that may be cut to a desired shape and/or size using scissors. In other implementations the coupler 60 may include one or more strips or pieces of adhesive material, one or more of which are not initially coupled to the housing 30, but which a user may decide how and in what configuration, and how many, of the strips or pieces of material to use to couple the housing 30 to the container 18 so as to cover some or all of the vents 20 and/or otherwise attempt to create a seal between the housing 30 and container 18 in an attempt to maximize the air that passes through the filter 70/72 during operation of the ventilation system 28. In implementations a coupler 60 having a specific shape and size, such as a cross shape, or a square shape, or a rectangular shape, or a circular shape, could be utilized. In implementations several shaped and/or sized couplers 60 could be sold together with the rest of the ventilation system 28 as a kit and the user may decide which coupler(s) 60 to use. In implementations a coupler 60 may include one or more easily tear-away portions in order to allow a user to size and shape the coupler 60 without the need for scissors.

In implementations the coupler 60 includes an adhesive that may allow a user to remove the coupler 60 from the container 18 when desired, though in other implementations the adhesive may be more permanent, such as requiring a user to cut the coupler 60 in order to decouple the housing 30 from the container 18. In implementations of a method of using a ventilation system 28, a user may notify a manufacturer or seller of a specific configuration of a container 18 and the manufacturer or seller may configure a coupler 60 to match the configuration of the container 18 before sending the ventilation system 28 to the user so as to maximize the percentage of the air exiting the container 18 that is forced through the filter 70 when the ventilation system 28 is installed and in operation. In implementations the coupler 60 could be configured to couple to the top of a container 18, or the side of a container 18, or both, and so forth. In implementations the adhesive element 66 could be configured to couple the housing 30 to the top of a container 18, or the side of a container 18, or both, and so forth. For example, in implementations the housing 30 could have a curved configuration and could be configured to couple to the curved edge of a container 18 between the top and side of the container 18.

In implementations the ventilation system 28 may omit an adhesive element 66 and may further omit a coupler 60 and may use gravity and/or a friction fit between the housing 30 and the container 18 in order to keep the housing 30 in place. In implementations other mechanisms may be used to couple the housing 30 to the container 18 such as, by non-limiting example: screws, tabs, a friction fit, glue, a magnet, hook-and-loop fasteners, and so forth. In implementations the coupler 60 may include a tape, such as a masking tape or a duct tape. In implementations the coupler 60 may be translucent and/or transparent to assist a user in seeing the vents 20 during placement of the coupler 60 so as to ensure the proper covering and/or closing of those vents 20 that are desired to be closed by the user.

The ventilation system 28 may be configured to work with any number and type of containers 18, whether or not the container 18 has a door 22, or regardless of the number and/or configuration and/or location of any vents 20, and/or regardless of the material of the container 18, whether polymer, a composite, or some other material. In implementations if a container 18 does not have sufficient vents 20 to allow proper use of the ventilation system 28 a user may form one or more openings in the container 18 to provide vents 20 for proper use of the ventilation system 28, such as by cutting an opening with a knife or other blade. In implementations the ventilation system 28 may come with implements to effectuate such a modification to the container 18.

In implementations the ventilation system 28 includes a release which allows the housing 30 to be opened for installation, removal and/or replacement of the filter 70/72 from the inside of the housing 30 and/or from the filter housing 38. In implementations the release may operate after the housing 30 has been coupled to the container 18 and/or the coupler 60 with the adhesive element 66 so that the filter 70/72 of the ventilation system 28 may be exchanged for a different (such as a newer) filter 70/72 after the ventilation system 28 has already been coupled to or installed on a container 18. In implementations the release may include a button which may in implementations be pushed or turned or tilted to operate the release. The release may include a spring element or some other bias, or the ventilation system 28 may include some other biasing mechanism, to bias the housing 30 to an open position such that when the release is operated the housing 30 opens of its own accord allowing a user to easily replace the filter 70/72 and/or the filter housing 38 and push against the housing 30 to overcome the bias and re-close the ventilation system 28. The release may include any elements or mechanisms to operate the selective opening of the ventilation system 28.

In implementations the ventilation system 28 includes a section 24 having an opening 26 for a power cord to pass through. The power cord would be couplable to the motor powering the fan 36 through the opening 26 and the other end of the power cord would be insertable into a standard electrical outlet.

Although the ventilation system 28 shown in the drawings is coupled to a top of a container 18, in implementations the ventilation system 28 may be coupled to the sides of a container 18 or any other area of a container 18.

In implementations the ventilation system 28 may be coupled to a container 18 and sold as a unit or sold together with a container 18 as a kit. In such implementations the container 18 could be specifically configured to receive the ventilation system 28 even, in some implementations, without the use of a coupler 60 and/or without the use of an adhesive element 66. For example the container 18 could include a recess allowing the ventilation system 28 to sit within the recess and, through the use of gravity and/or a friction fit and/or using seals, may allow the ventilation system 28 to ensure that substantially all of the air exiting the container 18 during operation of the ventilation system 28 passes through the filter 70 without the use of a coupler 60 and/or without the use of an adhesive element 66.

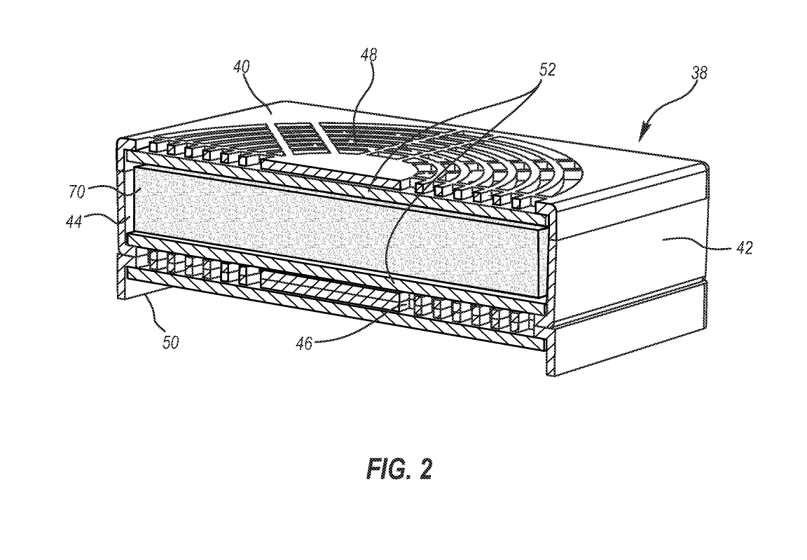

Referring again to FIG. 1, an exploded view of an implementation of a ventilation system 28 is shown. The ventilation system 28 includes a housing 30 having an inlet section 33 having an inlet 32, an outlet section 35 having an outlet 34, a fan 36, a guard 50 and a filter housing 38 having an upper housing 40 and a lower housing 42. Referring to FIG. 2, which is a front perspective cross-sectional view of the filter housing 38, filter 70 and guard 50 of FIG. 1 taken along line 2-2, in implementations a filter housing 38 includes an upper housing 40, a lower housing 42, a cavity 44 and two containment elements 52 between which a filter 70 resides. One containment element 52 is located on the top inner surface of the upper housing 40 and another is located on the bottom inner surface of the lower housing 42. The containment elements 52 are configured to allow air to move through the filter housing 38 while containing the filter 70 or loose filter material, such as charcoal, activated carbon, or the like, which is deposited into the cavity 44. The cavity 44 is thus configured to receive the filter 70 or loose filter material. In implementations the containment elements 52 include, by non-limiting example, a sponge, a sponge-like material or a polymeric porous material, or the like. A filter inlet 46 included in the lower housing 42 is configured to allow air to pass up through the lower housing 42 and through the filter 70 or loose filter material. A filter outlet 48 included in the upper housing 40 is configured to allow air exiting the filter 70 or loose filter material to pass upwards and exit the filter housing 38.

The guard 50 in implementations has openings that line up with and/or mirror those of the filter inlet 46. The guard 50 in implementations is configured to be coupled to the fan housing 37 so as to protect a user from inadvertently placing his/her finger or other item in too close proximity with the fan 36, such as to avoid injury or damage. The guard 50 may also prevent the filter 70 and/or loose filter material from entering the fan 36 and damaging the filter 70 or the fan 36. In implementations the guard 50 may be similar or identical to the upper housing 40. In implementations the guard 50 may be permanently coupled to the fan housing 37 such as, by non-limiting example, by gluing, by a friction fit, by a snap-on mechanism, by screws, by hook-and-loop fasteners, or by some other coupling mechanism.

The ventilation system 28 is configured such that the filter housing 38 may be discarded, when the filter 70 or filter material therein is expired and/or has become less efficient, and replaced with a new filter housing 38 having a new or fresh filter 70 or filter material. In implementations the filter housing 38 is not attached to the guard 50 but simply rests therein by gravity and/or by virtue of the outlet section 35 of the housing 30 being coupled to the inlet section 33 of the housing 30 in a fixed manner with the filter housing 38 housed therein. The inlet section 33 in implementations is releasably couplable/attachable to the outlet section 35. In implementations a user may change out the filter 70 and/or the filter material directly, such as by opening the filter housing 38 to access the filter 70 and/or the filter material. In implementations the filter material may be included within its own container, which container and filter material are together placed within the cavity 44. Such a container could include, by non-limiting example, an air-permeable or breathable mesh bag, or the like.

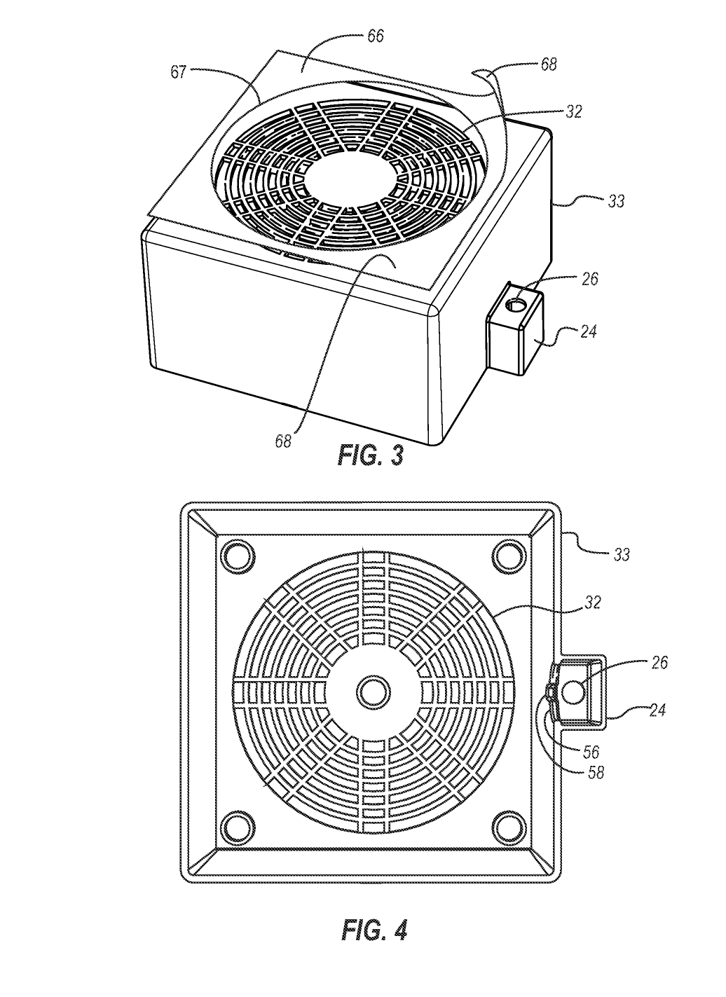

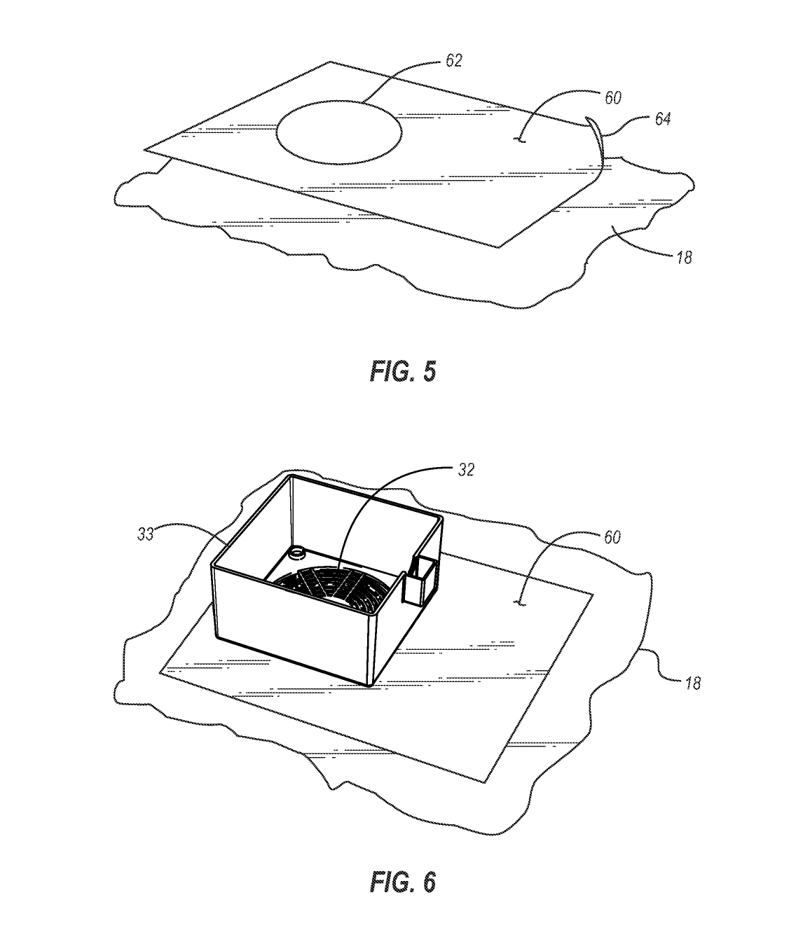

An implementation of an inlet section 33 is shown in FIGS. 1, 3-4, 6-7 and 9. An implementation of a coupler 60 is shown in FIGS. 5-7. FIG. 3 shows a top perspective view of an implementation of an inlet section 33. FIG. 4 shows a bottom view of an implementation of an inlet section 33. FIG. 5 shows a top perspective view of a coupler 60. FIG. 6 shows a top perspective view of the coupler 60 and a bottom perspective view of an inlet section 33. As may be imagined, the inlet section 33 could be rotated to any position relative to the coupler 60 when installed.

In implementations an inlet section 33 includes an inlet 32 and a section 24 extending outward from a sidewall of the inlet section 33. The section 24 may be shaped as shown in FIGS. 1, 3-4, 6-7 and 9, namely, having a cuboidal shape with one side missing, or it could have other shapes such as semi-spherical, semi-cylindrical, and so forth. The section 24 includes an opening 26 which, as described above, allows access for a power cord or the like for the fan 36 to be able to receive power or electricity.

As is visible in FIG. 4, in implementations the sidewall of the inlet section 33 corresponding with the section 24 may have a recess 56 aligned to some degree, generally, with the section 24 and/or with the opening 26. This may allow access for a power cord to pass from the section 24 into the interior of the inlet section 33. The recess 56 may have therein a deeper recess 58, which in implementations may include the shape of a slot, though in other implementations the deeper recess 58 may have another shape such as semi-circular, rectangular, and so forth. The deeper recess 58 may further allow ease of access for a power cord to enter the interior of the inlet section 33.

Implementations of an inlet section 33 may omit a section 24 entirely. By way of non-limiting example, in implementations one or more sidewalls of the inlet section 33 may include a recess 56 and/or a deeper recess 58 and this alone may allow a power cord to pass from outside the inlet section 33 into the interior of the inlet section 33. In implementations a recess 56, deeper recess 58 and section 24 may be omitted and one or more openings or holes may be present in one or more sidewalls of the inlet section 33 to allow a power cord to pass from outside the inlet section 33 to an interior of the inlet section 33.

In implementations an inlet section 33 may have an adhesive element 66 coupled to it in order to facilitate permanent or temporary coupling of the inlet section 33 to a coupler 60 and/or to a container 18. By way of non-limiting example, in the implementation shown in FIG. 3 the inlet section 33 has an adhesive element 66 coupled to and substantially covering the top outside surface of the inlet section 33 except that the adhesive element 66 has an opening 67 that generally corresponds and aligns with the inlet 32 so as to not obstruct the flow of air that passes through the inlet 32 during operation of the ventilation system 28. In implementations, as in those shown in the drawings, the adhesive element 66 has a removable backing 68 that can be removed to expose the adhesive of the adhesive element 66. Once this removable backing 68 is removed the adhesive of the adhesive element 66 may be contacted to a surface of the coupler 60 and/or a surface of the container 18 where it is desirable to permanently or temporarily couple the inlet section 33.

Although in implementations the inlet section 33 may have the adhesive element 66 on the outer top portion of the inlet section 33, in implementations the adhesive element 66 may be located alternatively or additionally on another portion of the inlet section 33, such as on the outside of one or more of the sidewalls. In such an implementation if, after coupling the inlet section 33 to the coupler 60 and/or the container 18, the inlet 32 is not close to and/or flush with or aligned with one or more of the vents 20 of the container 18 to ensure proper operation, another element, such as an air director, may be used to direct air flow from the one or more vents 20 to the inlet 32.

In implementations the inlet section 33 may be coupled to the container 18 and a coupler 60 may be omitted. In such implementations the adhesive element 66 may be coupled directly to the container 18, such as after removing a backing 68 from the adhesive element 66. In implementations the adhesive element 66 may come in a kit wherein the adhesive element 66 is not coupled to the inlet section 33 but the adhesive element 66 includes two backings 68, one on each flat planar surface, so that one can be removed in order to couple the adhesive element 66 to the top outer side of the inlet section 33, and the other backing 68 may be removed to couple the adhesive element 66 to the coupler 60 and/or container 18, in any order. In implementations the adhesive element 66 may come in a kit wherein the adhesive element 66 is not coupled to the inlet section 33 nor does the adhesive element 66 include an opening 67, but the user may manually provide an opening 67 in the adhesive element 66 prior to or after coupling the adhesive element 66 to the inlet section 33.

In implementations the adhesive of the adhesive element 66 may cover an entire side or surface of the adhesive element 66 on which the adhesive is present, and in other implementations the adhesive may cover only a portion of the adhesive element 66 on which the adhesive is present. By way of non-limiting example, in implementations it may be sufficient to only have multiple lines of adhesive, separated by lines of non-adhesive areas, both of which (or only the adhesive portions of which) are exposed by removal of one or more backings 68 in order to adhere the adhesive element 66 to the coupler 60 and/or to the container 18 and/or to the inlet section 33. In implementations the adhesive element 66 may include such a partial-only adhesive pattern on one or on both flat planar surfaces of the adhesive element 66.

In implementations a coupler 60 may be utilized to cover one or more vents 20 of the container 18. For example, this may be done to reduce the number of vents 20 of the container 18 that are not coupled to the ventilation system 28, so as to increase the amount of air flow through the container 18 that is forced to exit the container 18 through the ventilation system 28. In implementations the coupler 60 may be shaped and/or sized as shown in the figures. By way of non-limiting example, in implementations the coupler 60 may have the shape and/or size of a standard sheet of paper, such as about 8½ by 11 inches with a rectangular shape. In other implementations the coupler 60 could be any other size and any other shape such as round, oval, square, any other regular or irregular shape, and so forth. In implementations multiple smaller couplers 60 could be used, such as, for instance, many couplers 60 each used to cover one vent 20 or only a few vents 20 that is/are not coupled to the ventilation system 28.

In implementations the coupler 60 includes an opening 62. In implementations the opening 62 is shaped and sized to correspond and align with the inlet 32 of the inlet section 33. For example, Referring to FIGS. 5-6, in implementations the inlet section 33 may be aligned and/or positioned such that the inlet 32 aligns with the opening 62, such as to allow the free flow of air from inside the container 18 through one or more vents 20 into the ventilation system 28. As such, the opening 62 in implementations may be shaped and sized to match, at least roughly, or in implementations substantially, or in implementations exactly, the shape and size of the inlet 32. In implementations this may prevent the air flow from being limited by a mismatch in the shape and/or size of the opening 62 and inlet 32.

In implementations the opening 62 is alternatively, or additionally, shaped and sized to align with one or more vents 20 of the container 18, such as to allow the vents 20 to vent air from inside the container 18 to the ventilation system 28. In the implementation shown the opening 62 has the shape of a circle though in other implementations the opening 62 could have a different size and a different shape such as, by non-limiting example, a square, a rectangle, a triangle, an oval, and any other regular or irregular shape.

In implementations the coupler 60 is configured to constrain the air flow that can pass through one or more of the vents 20 so that the flow from the one or more vents 20 is effectively constrained, or shaped, to match with the size and shape of the inlet 32. For example, in some implementations the one or more vents 20 that are desired to direct air flow into the ventilation system 28 are likely to be shaped and/or sized differently than the inlet 32 of the inlet section 33. For example, the container 18 of FIGS. 7-8 has multiple vents 20 which, taken as a whole, form somewhat of an overall rectangular shape or footprint. The inlet 32, however, has a round or circular shape. Thus, in implementations a coupler 60 coupled to the container 18 could cover or block off some of the vents 20 so that the overall shape or footprint of the vents 20, through which air flow is allowed, effectively matches the overall shape or footprint of the inlet 32.

Although the couplers 60 in the implementations shown are coupled to the container 18 at an outside surface of the container 18, in implementations the coupler 60 could be coupled to the container 18 at an inside surface of the container 18. This could especially be done, for instance, in implementations wherein the housing 30 does not need to be coupled directly to the coupler 60 for proper operation. In other implementations, the housing 30 itself could, additionally or alternatively, be coupled to the container 18 at an inside surface of the container 18. For example, in implementations the housing 30 could be coupled to the inside of the top of the container 18 and the coupler 60 could be coupled to the outside of the top of the container 18. In implementations the housing 30 could be coupled to the inside of the top of the container 18 and the coupler 60 could also be coupled to the inside of the top of the container 18. In implementations the coupler 60 could be coupled to the inside of the top of the container 18 and the housing 30 could be coupled to the outside of the top of the container 18. In short, the housing 30 could be coupled to the inside or the outside of the top or any sidewall of the container 18, and the coupler 60 may be coupled to the inside or the outside of the top or any sidewall of the container 18.

In implementations wherein the housing 30 is coupled to the inside of the container 18, such as to the inside (or inner surface) of the top of the container 18 or the inside (or inner surface) of one of the sidewalls of the container 18, a power cord of the ventilation system 28 may pass underneath the container 18 to reach a power source, or it may be passed through the door 22 or one of the vents 20, or a hole or slot may be provided in one of the sidewalls and/or in the top of the container 18 to allow the power cord access to a power source. In implementations wherein the container 18 is sold with the ventilation system 28 as a kit, such a hole or slot could be provided in the sidewall and/or top of the container 18 to allow the power cord access to a power source.

In implementations the coupler 60 could be coupled to the container 18 and the inlet 32 of the inlet section 33 may then be aligned with the opening 62 of the coupler 60 and the inlet section 33 then coupled to the coupler 60, such as using the adhesive element 66. In implementations the inlet section 33 could first be coupled to the coupler 60, such as using the adhesive element 66, with the opening 62 and inlet 32 being in alignment, and the coupler 60 could then be coupled to the container 18.

In implementations a coupler 60 could include multiple openings 62. By way of non-limiting example, in implementations a coupler 60 could include two openings 62 such as to allow two vents 20 to have access to a single ventilation system 28 or inlet 32. In implementations two openings 62 could be present and each opening 62 could allow access to a separate ventilation system 28 or inlet 32. Naturally, any number of openings 62 could be utilized. The multiple openings 62 could be sized and positioned to be aligned with vents 20 of the container 18 and to correspond with a single or with multiple ventilation systems 28.

In implementations the coupler 60 includes an adhesive on one side and a backing 64 which may be removed to expose the adhesive, such as to allow the coupler 60 to be temporarily or permanently coupled to the container 18. In implementations the adhesive may cover the entire side of the coupler 60 on which the adhesive is present, though in other implementations the adhesive may only cover a portion of the side of the coupler 60 on which the adhesive is present.

Although the coupler 60 is called a “coupler”, this is not meant to be limiting. For example, the coupler 60 does not have to couple the inlet section 33, or any other part of the ventilation system 28, to the container 18. The coupler 60 nevertheless couples at least itself to the container 18, and in this sense the term “coupler” is not a misnomer for the coupler 60.

In implementations the adhesive element 66 and coupler 60 could be integrated or included in a single element. By way of non-limiting example, in implementations the adhesive element 66 could in implementations be enlarged such that its outer edges extend outwards beyond the edges of the top outer surface of the inlet section 33. In implementations, for example, the adhesive element 66 could have a size similar to that of the coupler 60 shown in the figures. In such implementations the adhesive element 66 could be pre-coupled to the inlet section 33 when sold such that a user does not have to couple the adhesive element 66 to the inlet section 33. In other implementations the adhesive element 66 could have two backings 68, one on each flat planar surface, so that the user may remove one backing 68 from one side of the adhesive element 66 to couple the adhesive element 66 to the inlet section 33, and the user may also remove the other backing 68 from the other side of the adhesive element 66 to couple the adhesive element 66 to the container 18, in any order. In such implementations the backing 68 on the side of the adhesive element 66 that will be coupled to the inlet section 33 may have several removable portions, such as various shaped and/or sized removable sections, so that the removed portion(s) may be chosen and removed so as to correspond with the size and/or shape of the portion of the inlet section 33 to where the adhesive element 66 will be adhered. In implementations the adhesive (and in implementations the backing 68) on the side of the adhesive element 66 configured to couple to the inlet section 33 may be sized to generally cover about an entire side or surface, such as about the entire top outer side or surface, of the inlet section 33, and the adhesive element 66 may have an opening 67 sized and shaped similarly to the inlet 32 so as to be aligned therewith so as to not obstruct the flow of air through inlet 32.

In the implementations shown in the figures the coupler 60 is transparent. This may assist a user in placement of the coupler 60, such as allowing a user to easily see to correctly place the coupler 60 in an optimal position to block the vents 20 that are desired to be blocked for best operation of the ventilation system 28. Having a coupler 60 that is transparent also has the advantage of not changing the look of a container 18 or litter box as much as would otherwise occur with a coupler 60 that is opaque. A transparent coupler 60 may thus be more aesthetically pleasing. In other implementations the coupler 60 may be opaque and may be any color. For example in implementations the coupler 60 may be colored to match a color of the container 18.

The inlet section 33 may be temporarily or permanently positioned at various rotations with respect to the coupler 60 and/or with respect to a container 18, such as through the use of any of the adhesive or other mechanisms described herein. This may be useful, by non-limiting example, to face the inlet section 33 so that a power cord is positioned towards an electrical outlet. For any of the adhesive items or elements described herein the adhesive may be a permanent adhesive such as to permanently bind two items or the adhesive may be a temporary adhesive such as to allow removal and repositioning or re-adhering of two items.

Implementations of methods of use of a ventilation system 28 may include one, all, or any of the following steps, performed in any order: removing a backing 64 from a coupler 60 to expose an adhesive; coupling the coupler 60 to an outer surface of a top of a container 18 using the adhesive; removing a backing 68 from an adhesive element 66 coupled to an inlet section 33 to expose an adhesive; aligning an inlet 32 of the inlet section 33 with an opening 62 of the coupler 60; coupling the inlet section 33 to one of the coupler 60 and container 18 with the inlet 32 in alignment with the opening 62; coupling one of a filter 70/72 and a filter housing 38 to a housing 30; coupling a fan 36 to the housing 30; providing power to the fan 36; and exchanging an old filter 70/72, filter housing 38 or filter material of the filter 70/72 with a new filter 70/72, new filter housing 38 or new filter material of the filter 70/72.

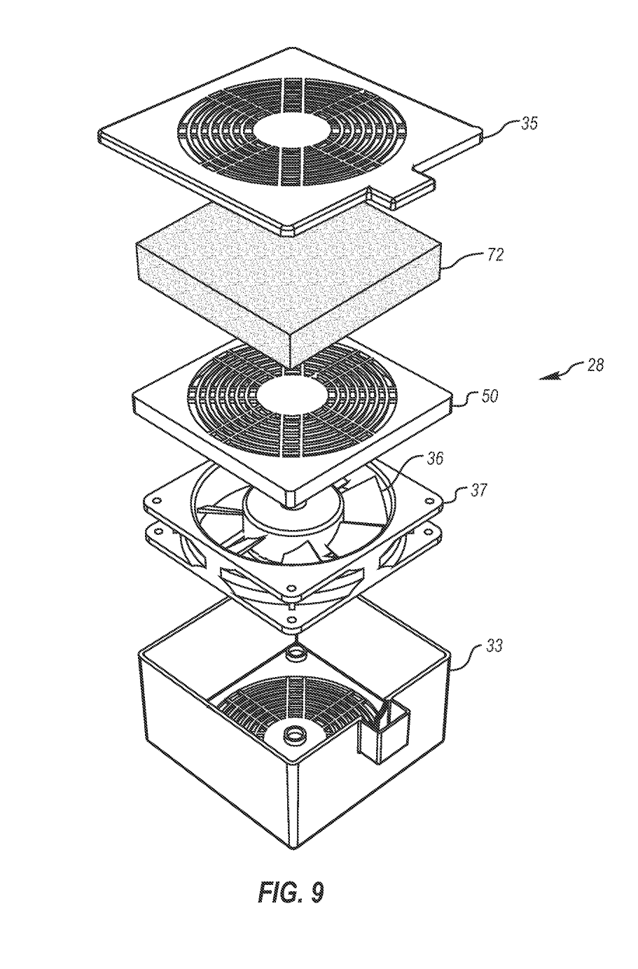

Referring now to FIG. 9, in implementations the filter housing 38 is omitted and a ventilation system 28 includes a housing 30 including an inlet section 33 having an inlet 32 configured for air to pass through and an outlet section 35 removably coupled to the inlet section 33, the outlet section 35 having an outlet 34 configured for air to pass through; a fan 36 coupled entirely within the housing 30, a filter 72 removably coupled entirely within the housing 30, a litter box coupled to the housing 30, and a guard 50 resting atop the fan housing 37 and providing a location for the filter 72 to rest upon; wherein the ventilation system 28 defines a flow direction for air exiting the litter box and wherein the fan 36 is positioned prior to the filter 72 in the flow direction. Having the fan 36 positioned prior to the filter 72 in the flow direction can make it easier to remove and replace the filter 72 because, as can be seen from FIG. 9, the filter 72 is the topmost item within the housing 30 below the outlet section 35 and, as such, the outlet section 35 of the housing 30 may be removed, the filter 72 replaced, and the outlet section 35 put back in place. In this manner, the filter 72 may be changed without decoupling the housing 30 from the litter box. In implementations the guard 50 may be omitted and the filter 72 may rest directly atop the fan housing 37. In such implementations the filter 72 may be rigid enough and/or have enough structural integrity such that the filter 72 does not interrupt or negatively affect operation of the fan 36 nor does the fan 36 damage the filter 72.

In implementations the fan 36 is housed entirely within a fan housing 37 that is removably coupled entirely within the housing 30. In implementations the inlet section 33 has the shape of a hollow cuboid with one face removed. The removed face in implementations is the face that faces upwards. In implementations this has the advantage of ease of assembly, for instance the other faces of the cuboid can prevent the fan housing 37 and filter 72 and/or filter housing 38 and filter 70 from shifting relative to one another and gravity can keep them all in place otherwise, so that no elements need to be screwed or otherwise held in place (though in implementations they may be screwed or otherwise held in place). The outlet section 35 in implementations is a flat lid. This construction assists with ease of operation, as detailed some above, in that the outlet section 35 alone needs to be removed in order to change the filter 72 or filter housing 38 and filter 70.

In implementations the coupler 60 is transparent. In implementations the coupler 60 includes an opening 62 that is substantially aligned with the inlet section 33. In implementations the opening 62 is a circle and the inlet section 33 is a circle, and both circles are coaxial with one another. In implementations the adhesive element 66 is coupled to the inlet section 33 and has an opening 67 aligned with the inlet 32. In implementations the opening 67 of the adhesive element 66 is a circle and the inlet 32 is a circle and both circles are coaxial with one another. In implementations the adhesive element 66 is coupled to one of the litter box and a coupler 60 coupled to the litter box.

In implementations the inlet 32 is a circular vent and the outlet 34 is a circular vent. In implementations the housing 30 is coupled to the litter box only at a top of the litter box.

In implementations a ventilation system 28 includes a housing 30 having an inlet section 33 with an inlet 32 configured for air to pass through and an outlet section 35 removably coupled to the inlet section 33, the outlet section 35 having an outlet 34 configured for air to pass through, a fan 36 coupled entirely within the housing 30, a filter 72 removably coupled entirely within the housing 30, an adhesive element 66 coupled to a bottom of the housing 30 and having an opening 67 aligned with the inlet 32, a transparent coupler 60 coupled to the adhesive element 66, and a litter box coupled to the transparent coupler 60, wherein the transparent coupler 60 blocks at least one vent 20 of the litter box and wherein the transparent coupler 60 has an opening 62 aligned with the inlet section 33. In implementations the ventilation system 28 is configured to allow the filter 72 to be removed and replaced while the inlet section 33 is coupled to the litter box.

In implementations a ventilation system 28 includes a housing 30 having an inlet section 33 with an inlet 32 configured for air to pass through and an outlet section 35 removably coupled to the inlet section 33, the outlet section 35 having an outlet 34 configured for air to pass through, a fan 36 coupled entirely within the housing 30, a filter 72 removably coupled entirely within the housing 30, and a litter box coupled to the housing 30, wherein the ventilation system 28 defines substantially only a single flow direction for air exiting the litter box, the flow direction being vertically upwards from the litter box. In implementations the ventilation system 28 defines only a single, vertical, cylindrical column within which the air exiting the litter box flows. For example, referring to FIG. 9, it can be seen that the inlet 32, fan housing 37, guard 50 and outlet 34 each have a circular opening or a circular vent so that, when stacked together, they form a single, vertical, cylindrical column within which the air exiting the litter box flows. Additionally, referring to FIG. 1, it can be seen that the inlet 32, fan housing 37, filter housing 38 and outlet 34 each have a circular opening or a circular vent so that, when stacked together, they form a single, vertical, cylindrical column within which the air exiting the litter box flows.

Having the air exiting the litter box flow in only a single direction through the ventilation system 28 and only in an upwards direction from the litter box may and/or only in a cylindrical column, in implementations, may have the advantages of: reducing the amount of electricity that is needed to run the fan 36 (due to less loss from air friction due to turns and redirection of the air); reduced noise; longer life of the ventilation system 28; simpler and more inexpensive construction, assembly, disassembly, part replacement and repair; and the like.

The ventilation system 28 may be made of conventional materials used to make goods similar to these in the art, such as, by non-limiting example, polymers, composites, ceramics, metals, and the like. Those of ordinary skill in the art will readily be able to select appropriate materials and manufacture these products from the disclosures provided herein. Descriptions, details and variations related to elements described throughout this disclosure with respect to particular implementations may be applied to similar elements of other implementations. For example, elements, details and variations related to any element, component, sub-element or sub-component of ventilation system 28 may be applied to, and/or interchanged with, any other element, component, sub-element or sub-component of the ventilation system 28. Elements, details and variations related to a filter 70 may be applied to and/or interchanged with a filter 72, and vice versa. This same reasoning may apply to any of the elements herein having similar names.

In implementations a method of changing a filter 70 of a ventilation system 28 may include decoupling the outlet section 35 from the inlet section 33, removing the filter housing 38, separating the upper housing 40 from the lower housing 42, removing the filter 70, replacing the filter 70 with a new (or clean) filter 70, coupling the upper housing 40 to the lower housing 42, placing the filter housing 38 back in the housing 30, and coupling the outlet section 35 back to the inlet section 33. This may be done before the ventilation system 28 is installed on a litter box or, in implementations, it may be done while the inlet section 33 is coupled to a litter box, and without decoupling the inlet section 33 from the litter box.

In implementations a method of changing a filter 72 of a ventilation system 28 may include decoupling the outlet section 35 from the inlet section 33, removing the filter 72, replacing the filter 72 with a new (or clean) filter 72, and coupling the outlet section 35 back to the inlet section 33. This may be done before the ventilation system 28 is installed on a litter box or, in implementations, it may be done while the inlet section 33 is coupled to a litter box, and without decoupling the inlet section 33 from the litter box.

In places where the description above refers to particular implementations of ventilation systems and related methods and implementing components, sub-components, methods and sub-methods, it should be readily apparent that a number of modifications may be made without departing from the spirit thereof and that these implementations, implementing components, sub-components, methods and sub-methods may be applied to other ventilation systems and related methods.

What is claimed is:

1. A ventilation system, comprising:
a housing comprising an inlet section having an inlet configured for air to pass through and an outlet section removably coupled to the inlet section, the outlet section having an outlet configured for air to pass through;
a fan coupled entirely within the housing; and
a filter removably coupled entirely within the housing;
wherein the housing is configured to be coupled to a litter box, wherein the ventilation system defines a flow direction for air exiting the litter box, and wherein the fan is positioned prior to the filter in the flow direction.

2. The system of claim 1, further including a litter box coupled to the housing.

3. The system of claim 1, wherein the inlet section comprises a shape of a hollow cuboid with one face removed.

4. The system of claim 1, wherein the outlet section comprises a flat lid.

5. The system of claim 1, further comprising a coupler coupled to the litter box and blocking at least one vent of the litter box, the coupler having an opening aligned with the inlet.

6. The system of claim 1, further comprising an adhesive element coupled to the inlet section and having an opening substantially aligned with the inlet, the adhesive element coupled to one of the litter box and a coupler coupled to the litter box.

7. The system of claim 1, wherein the inlet comprises a circular vent and wherein the outlet comprises a circular vent.

8. The system of claim 1, wherein the housing is coupled to the litter box only at a top of the litter box.

9. The system of claim 1, wherein the filter is the topmost item within the housing below the outlet section.

10. A ventilation system, comprising:
a housing comprising an inlet section having an inlet configured for air to pass through and an outlet section removably coupled to the inlet section, the outlet section having an outlet configured for air to pass through;
a fan coupled entirely within the housing;
a filter removably coupled entirely within the housing;
an adhesive element coupled to a bottom of the housing and having an opening aligned with the inlet;
a transparent coupler coupled to the adhesive element; and
a litter box coupled to the transparent coupler;
wherein the transparent coupler blocks at least one vent of the litter box and wherein the transparent coupler has an opening aligned with the inlet.

11. The system of claim 10, wherein the inlet section comprises a shape of a hollow cuboid with one face removed.

12. The system of claim 10, wherein the outlet section comprises a flat lid.

13. The system of claim 10, wherein the filter is the topmost item within the housing below the outlet section.

14. The system of claim 10, wherein the ventilation system is configured to allow the filter to be removed and replaced while the inlet section is coupled to the litter box.

15. A ventilation system, comprising:
a housing comprising an inlet section having an inlet configured for air to pass through and an outlet section removably coupled to the inlet section, the outlet section having an outlet configured for air to pass through;
a fan coupled entirely within the housing;
a filter removably coupled entirely within the housing; and
a litter box coupled to the housing;
wherein the ventilation system defines substantially only a single flow direction for air exiting the litter box, the flow direction being vertically upwards from the litter box.

16. The system of claim 15, wherein the ventilation system defines only a single, vertical, cylindrical column within which the air exiting the litter box flows.

17. The system of claim 15, wherein the inlet comprises a circular vent and the outlet comprises a circular vent coaxial with the circular vent of the inlet.

18. The system of claim 15, wherein the inlet section comprises a shape of a hollow cuboid with one face removed.

19. The system of claim 15, wherein the outlet section comprises a flat lid.

20. The system of claim 15, wherein the filter is the topmost item within the housing below the outlet section.
